(19) United States
(12) Patent Application Publication
(10) Pub. No.: US 2022/0002884 A1
(43) Pub. Date: Jan. 6, 2022

(54) METHOD FOR SYNTHESIZING AMMONIA USING METAL NANOPARTICLES IN A FUEL CELL

(71) Applicants: Saudi Arabian Oil Company, Dhahran (SA); Korea Advanced Institute of Science and Technology, Daejeon (KR)

(72) Inventors: Sai P. Katikaneni, Dhahran (SA); Kunho Lee, Dhahran (SA); Kangyong Lee, Daejeon (KR); Joongmyeon Bae, Daejeon (KR); WooChul Jung, Daejeon (KR)

(73) Assignees: Saudi Arabian Oil Company, Dhahran (SA); Korea Advanced Institute of Science and Technology, Daejeon (KR)

(21) Appl. No.: 17/367,890

(22) Filed: Jul. 6, 2021

Related U.S. Application Data
(60) Provisional application No. 63/048,262, filed on Jul. 6, 2020.

(51) Int. Cl. C25B 1/27; H01M 8/1246; H01M 8/1213; H01M 4/88; H01M 4/92; C25B 1/50; C25B 9/19; C25B 11/054; C25B 11/067; C25B 11/081; C25B 13/07

(52) U.S. Cl. CPC C25B 1/27; H01M 8/1246; H01M 8/1213; H01M 4/881; H01M 4/925; H01M 2008/1293; C25B 9/19; C25B 11/054; C25B 11/067; C25B 11/081; C25B 13/07; C25B 1/50

(57) ABSTRACT

According to embodiments of the present disclosure, a solid oxide fuel cell includes a cathode, an anode, and a solid oxide electrolyte disposed between the anode and the cathode. The anode includes a porous scaffold that includes a solid oxide having one or more metal nanoparticles disposed on one or more surfaces of the porous scaffold. The porous scaffold and the solid oxide electrolyte are formed from La_{0.8}Sr_{0.2}Ga_{0.83}Mg_{0.17}O_{2.815} (LSGM), and the metal nanoparticles are selected from the group consisting of platinum, nickel, gold, and combinations thereof. Methods of synthesizing ammonia using the fuel cell are also described.

### CROSS-REFERENCE TO RELATED APPLICATION

This application claims priority to U.S. Provisional Application Ser. No. 63/048,262 filed Jul. 6, 2020, the entire content of which is hereby incorporated by reference.

### TECHNICAL FIELD

Embodiments described herein relate generally to methods for synthesizing ammonia, and more particularly to methods for synthesizing ammonia using a fuel cell including metal nanoparticles.

### BACKGROUND

Hydrogen has been studied as a source of energy because it is free of carbon dioxide (CO₂), a major component in greenhouse gas (GHG) emissions. However, hydrogen has a low gravimetric energy density and is difficult to handle because of its low liquefaction temperature. Various hydrogen carriers have been studied, and among one of the most promising is ammonia. In particular, ammonia has a low liquefaction pressure at room temperature, and it can be stored and transported efficiently. Additionally, ammonia is CO₂-free and has a 17 wt % higher gravimetric hydrogen capacity as compared to other liquid organic hydrogen carriers.

The main industrial process for the mass production of ammonia from the nitrogen in the air is the Haber-Bosch process, which produces gaseous ammonia by combining gaseous hydrogen and nitrogen at high temperature and pressure with an iron-based heterogeneous catalyst according to the following reaction:

N₂(g)+3H₂(g)→2NH₃(g)

This redox reaction can cause cell degradation or even electrolyte cracking by increasing interfacial polarization between the anode and electrolyte. Moreover, industrial processes that synthesize ammonia through steam reforming produce a significant amount of CO₂.

### SUMMARY

Based on the foregoing, approaches to produce ammonia without carbon dioxide (CO₂) in solid oxide fuel cells may be desired. Various embodiments described herein meet those needs and are directed to methods for synthesizing ammonia and solid oxide fuel cells (SOFC) for carrying out the same. In embodiments, the solid oxide fuel cell includes a cathode, an anode, and a solid oxide electrolyte disposed between the anode and the cathode. The anode includes a porous scaffold that includes a solid oxide having one or more metal nanoparticles disposed on one or more surfaces of the porous scaffold. The porous scaffold and the solid oxide electrolyte are formed from La_{0.8}Sr_{0.2}Ga_{0.83}Mg_{0.17}O_{2.815} (LSGM), and the metal nanoparticles are selected from the group consisting of platinum, nickel, gold, and combinations thereof.

According to an embodiment of the present disclosure, a method of producing ammonia in a fuel cell includes ionizing hydrogen gas to an anode of the fuel cell by removing electrons to form hydrogen ions. The fuel cell comprises a cathode, the anode, and a proton-conducting electrolyte between the anode and the cathode. The anode comprises a porous scaffold and one or more metal nanoparticles disposed on the surface of the porous scaffold. The proton-conducting electrolyte and the porous scaffold comprise La_{0.8}Sr_{0.2}Ga_{0.83}Mg_{0.17}O_{2.815} (LSGM) and the metal nanoparticles are selected from the group consisting of platinum, nickel, gold, and combinations thereof. The method further includes passing the hydrogen ions through the proton-conducting electrolyte to the cathode, passing the electrons from the anode to the cathode, and passing nitrogen gas to the cathode, wherein the hydrogen ions and the nitrogen gas react to produce the ammonia.

These and other embodiments are described in more detail in the following Detailed Description, as well as the appended drawings. The accompanying drawings are included to provide a further understanding of the various embodiments, and are incorporated into and constitute a part of this specification. The drawings illustrate the various embodiments described herein, and together with the description, serve to explain the principles and operations of the claimed subject matter.

### BRIEF DESCRIPTION OF THE DRAWINGS

Referring now to the illustrative examples in the drawings:

FIG. 1 is an illustration of an example solid oxide fuel cell measurement rig loaded with a solid oxide fuel cell single cell to evaluate electrochemical performance of a solid oxide fuel cell single cell according to one or more embodiments shown and described herein;

FIG. 2 is another illustration of an example solid oxide fuel cell measurement rig loaded with a solid oxide fuel cell single cell to evaluate electrochemical performance of a solid oxide fuel cell single cell according to one or more embodiments shown and described herein;

FIG. 3A is a scanning electron microscope (SEM) image of an LGSM scaffold infiltrated with palladium according to one or more embodiments shown and described herein;

FIG. 3B is an SEM image of an LGSM scaffold infiltrated with nickel according to one or more embodiments shown and described herein;

FIG. 3C is an SEM image of an LGSM scaffold infiltrated with cobalt according to one or more embodiments shown and described herein;

FIG. 3D is an SEM image of an LGSM scaffold infiltrated with copper according to one or more embodiments shown and described herein;

FIG. 3E is an SEM image of an LGSM scaffold infiltrated with silver according to one or more embodiments shown and described herein; FIG. 3F is an SEM image of an LGSM scaffold infiltrated with platinum according to one or more embodiments shown and described herein;

FIG. 4A is an SEM image of an LGSM scaffold infiltrated with 10 mM nickel according to one or more embodiments shown and described herein;

FIG. 4B is an SEM image of an LGSM scaffold infiltrated with 50 mM nickel according to one or more embodiments shown and described herein;

FIG. 4C is a magnified view of the SEM image in FIG. 4A;

FIG. 4D is a magnified view of the SEM image in FIG. 4B;

FIG. 5A is a graph showing the resultant pressure gradient for a channel flow design simulation for a first flow channel design according to one or more embodiments shown and described herein;

FIG. 5B is a graph showing the resultant pressure gradient for a channel flow design simulation for a second flow channel design according to one or more embodiments shown and described herein;

FIG. 5C is a graph showing the resultant pressure gradient for a channel flow design simulation for flow channels having a zig-zag design according to one or more embodiments shown and described herein;

FIG. 6 is a graph of the NH3 yield rate (Y-axis; in ×10⁻¹² mol/cm²*s) for Samples A-F according to one or more embodiments shown and described herein;

FIG. 7 is a graph showing results from electrochemical impedance spectroscopy measurements using a comparative electrode and using an electrode according to one or more embodiments shown and described herein; and

FIG. 8 is a schematic diagram of modeled equivalent circuits using a comparative electrode and using an electrode according to one or more embodiments shown and described herein.

### DETAILED DESCRIPTION

Specific embodiments of the present application will now be described. The disclosure may, however, be embodied in different forms and should not be construed as limited to the embodiments set forth in this disclosure. Rather, these embodiments are provided so that this disclosure will be thorough and complete, and will fully convey the scope of the subject matter to those skilled in the art.

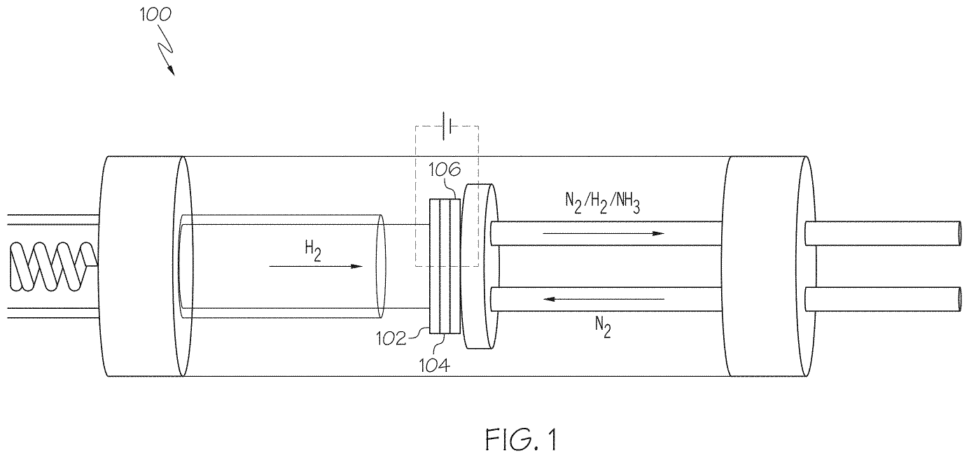

FIG. 1 illustrates an example solid oxide fuel cell (SOFC) measurement rig loaded with a solid oxide fuel cell (SOFC) single cell 100 to evaluate electrochemical performance of the SOFC cell 100. The SOFC cell 100 includes an anode 102, an electrolyte 104, and a cathode 106.

In various embodiments, the anode 102 is in the form of a porous scaffold. As used herein, the term “porous” means a structure including one or more pores to permit flow of gas and impregnation of metal catalysts. The porous scaffold of various embodiments is a solid oxide. In embodiments, the solid oxide can be, for example, La_{0.8}Sr_{0.2}Ga_{0.83}Mg_{0.17}O_{2.815} (LSGM), BaZr_{0.9}Y_{0.1}O_{3-δ} (BZY), BaCe_{0.6}Zr_{0.2}Y_{0.2}O_{3-δ} (BCZY), Ce_{0.9}Gd_{0.1}O_{1.95} (GDC), Sm_{0.2}Ce_{0.8}O_{1.9} (SDC), La_{0.75}Sr_{0.25}Cr_{0.50}Mn_{0.50}O₃ (LCSM), PrBaMn₂O_{5+δ} (PMBO), or combinations thereof. In embodiments, the anode 102 is La_{0.8}Sr_{0.2}Ga_{0.83}Mg_{0.17}O_{2.815} (LSGM). In various embodiments, the porous scaffold includes one or more nano-scale advanced metal catalysts within the scaffold structure.

For example, the anode 102 also includes metal-based catalysts disposed on one or more surfaces of the porous scaffold. In embodiments, the metal-based catalysts are at least partially embedded below or within the surface of the porous scaffold. For example, nano-scale catalysts (e.g., LCSF, LST, LSCM, PMBO, and the like) can be embedded within the scaffold structure by impregnating the scaffold structure with the catalyst after fabrication of the scaffold structure. Accordingly, agglomeration of the nano-scale catalysts can be avoided and high performance can be obtained despite the use of a perovskite material due to the high surface area of the catalyst.

In various embodiments, the metal-based catalyst can be a metal or metal oxide. Metals suitable for use as the catalyst include, for example, nickel, platinum, gold, or combinations thereof. In embodiments, the metal-based catalyst is in the form of nanosized particles, or nanoparticles, for example, from 1 nm to 100 nm, or from 10 nm to 100 nm. Without being bound by theory, it is believed that infiltration of the scaffold with nanosized catalyst particles can achieve high electrochemical performance and durability by increasing the triple phase boundary (TPB) length. In particular, the dispersion of the catalyst along many surfaces of a scaffold provides many reaction sites for the electrochemical reaction of the SOFC.

The electrolyte 104 is a proton-conducting and solid oxide electrolyte that comprises a dense solid oxide that is sandwiched between the anode 102 and the cathode 106. As used herein, a “dense” electrolyte is an electrolyte through which oxygen and hydrogen cannot pass and which completely separates the two gases. The solid oxide electrolyte may include, for example, La_{0.8}Sr_{0.2}Ga_{0.83}Mg_{0.17}O_{2.815} (LSGM), BaZr_{0.9}Y_{0.1}O_{3-δ} (BZY), BaCe_{0.6}Zr_{0.2}Y_{0.2}O_{3-δ} (BCZY), Ce_{0.9}Gd_{0.1}O_{1.95} (GDC), Sm_{0.2}Ce_{0.8}O_{1.9} (SDC), or combinations thereof. In embodiments, the solid oxide of the solid oxide electrolyte is the same solid oxide as is included in the porous scaffold of the anode.

In various embodiments, the cathode 106 includes, for example, perovskite materials, for example, lanthanum strontium manganite (LSM)-based perovskites. Other example cathode compositions include Sr-doped lanthanum ferrite (LSF) materials and Sr-doped lanthanum ferro-cobaltite (LSCF) materials. In embodiments, the cathode includes La_{0.6}Sr_{0.4}Co_{0.2}Fe_{0.8}O₃ (LSCF) infiltrated with La₁₋ₓSrₓMnO₃ (LSM). In embodiments, the cathode 106 includes a porous scaffold comprising metal catalysts disposed on one or more surfaces of the porous scaffold. In such embodiments, the metal catalysts may be as described above with respect to the structure of the anode 102.

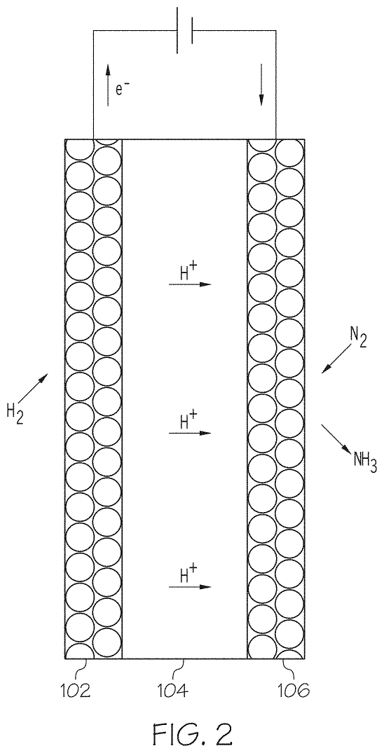

In operation, a hydrogen feed flows hydrogen gas (H₂) into the system, as shown in FIGS. 1 and 2. As the H₂ gas contacts the anode, the hydrogen is ionized by removing electrons (e⁻). Ionization of the hydrogen gas by the anode proceeds according to the following reaction:

H₂→2H⁺+2e⁻

The hydrogen ions (H⁺) travel through the solid oxide electrolyte to the cathode, where they react with nitrogen gas (N₂) and electrons (e⁻) to generate NH₃ according to the following reaction:

N₂+6H⁺+6e⁻→2NH₃

The electrons (e⁻) flow from the anode into an electronic circuit and back into the cathode, where they are used to reduce the nitrogen gas (N₂). The electronic circuit uses the flow of electrons to power a device.

In various embodiments, the scaffold is made by a screen printing method in which a paste is printed on the top of substrate. The paste is made by mixing scaffold material with an ink vehicle. The ink vehicle, in various embodiments, is composed of alpha-terpineol, ethyl cellulose, polyvinyl butyral, dibutyl phthalate, poly ethylene glycol. Following printing, the paste is dried and sintered at high temperature between 1000° C. and 1250° C., forming the scaffold. Then, catalyst precursor solutions (nitrate or citrate, etc.) are infiltrated into the scaffold, and calcined at 500° C. Infiltration is repeated until the amount of catalyst reaches 25-30 wt % of the weight of scaffold.

According to an aspect, either alone or in combination with any other aspect, a solid oxide fuel cell includes a cathode, an anode, and a solid oxide electrolyte disposed between the anode and the cathode. The solid oxide electrolyte comprises La_{0.8}Sr_{0.2}Ga_{0.83}Mg_{0.17}O_{2.815} (LSGM). The anode comprises a porous scaffold, the porous scaffold comprising LSGM and one or more metal nanoparticles disposed on the surface of the porous scaffold. The metal nanoparticles are selected from the group consisting of platinum, nickel, gold, and combinations thereof.

According to a second aspect, either alone or in combination with any other aspect, the cathode comprises a porous scaffold, the porous scaffold comprising LSGM and one or more metal nanoparticles disposed on the surface of the porous scaffold. The metal nanoparticles are selected from the group consisting of platinum, nickel, gold and combinations thereof.

According to a third aspect, either alone or in combination with any other aspect, the cathode comprises a porous scaffold, the porous scaffold comprising a solid oxide having metal-based catalysts disposed on one or more surfaces of the porous scaffold.

According to a fourth aspect, either alone or in combination with any other aspect, the cathode comprises La_{0.6}Sr_{0.4}Co_{0.2}Fe_{0.8}O₃ (LSCF) infiltrated with La₁₋ₓSrₓMnO₃ (LSM).

According to a fifth aspect, either alone or in combination with any other aspect, a method of producing ammonia in a fuel cell includes ionizing hydrogen gas at an anode of the fuel cell by removing electrons to form hydrogen ions, the fuel cell comprising a cathode, the anode, and a proton-conducting electrolyte between the anode and the cathode; passing the hydrogen ions through the proton-conducting electrolyte to the cathode; passing the electrons from the anode to the cathode; and passing nitrogen gas to the cathode, wherein the hydrogen ions and the nitrogen gas react to produce the ammonia. In the fuel cell, the proton-conducting electrolyte comprises La_{0.8}Sr_{0.2}Ga_{0.83}Mg_{0.17}O_{2.815} (LSGM), and the anode comprises a porous scaffold, the porous scaffold comprising LSGM and one or more metal nanoparticles disposed on the surface of the porous scaffold, wherein the metal nanoparticles are selected from the group consisting of platinum, nickel, gold, and combinations thereof.

According to a sixth aspect, either alone or in combination with any other aspect, the cathode comprises a porous scaffold, the porous scaffold comprising LSGM and one or more metal nanoparticles disposed on the surface of the porous scaffold. The metal nanoparticles are selected from the group consisting of platinum, nickel, gold and combinations thereof.

According to a seventh aspect, either alone or in combination with any other aspect, the cathode comprises a porous scaffold, the porous scaffold comprising a solid oxide having metal based catalysts disposed on one more surfaces of the porous scaffold.

According to an eighth aspect, either alone or in combination with any other aspect, the cathode comprises La_{0.6}Sr_{0.4}Co_{0.2}Fe_{0.8}O₃ (LSCF) infiltrated with La₁₋ₓSrₓMnO₃ (LSM).

According to a ninth aspect, either alone or in combination with any other aspect, passing the electrons from the anode to the cathode comprises passing the electrons from the anode to the cathode through an electronic circuit.

### EXAMPLES

The following examples illustrate features of the present disclosure but are not intended to limit the scope of the disclosure.

### Example 1

In order to compare electrochemical activity of various catalysts, electrolytes with proton conductivity were used to form solid oxide fuel cells. Specifically, electrolyte supports were fabricated by mixing LGSM powder and 1-3 wt % of a proper binder system (polyvinyl alcohol) by ball-milling for 24 hours. The mixture was then dried at a temperature of from 100° C. to 200° C. until fully dried (at least 1 hour) and sieved using a 100 μm sieve. Three grams (3 g) of the powder was pelletized into a disk pellet at a pressure of 10 MPa. Pellets were sintered at 1450° C. for 4 hours.

Cells were formed using platinum, gold, and silver pastes. The metal pastes were screen-printed with a thickness of about 10 μm on both sides of a LGSM pellet. Platinum and gold pastes were cured at 930° C. for 1 hour and the silver paste was cured at 850° C. for 1 hour. Each resulting cell was tested at 600° C. and 1.6 volts (V) with a metallic jig to capture produced ammonia on the cathode side. To prevent oxidation of the metallic jig, Crofer 22 APU was used to provide an electrical connection between the potentiostat and the fabricated cell, and the capture of ammonia. The concentration of ammonia produced was detected using ammonia-3L detecting tubes (available from Gastec Co. Ltd.) connected at the exhaust side of the cathode jig.

The highest rate of formation was on the surface of the silver electrode with a value of 1.30×10⁻¹⁰ mol/cm²*s. The rate of formation of ammonia on the platinum electrode was roughly half that of the silver electrode, and gold demonstrated a negligible amount of ammonia. These results confirmed previous studies, which suggested that silver aids in selective reduction of protons to form ammonia, while platinum promotes hydrogen evolution on the cathode rather than ammonia formation.

### Example 2

To increase the surface area of the electrode and the corresponding formation rate, scaffold-structured electrodes were introduced. In particular, two methods were used to disperse metal nanoparticles on LSGM scaffolds. In the first method, metal nanoparticles were synthesized by infiltration of metal precursors directly on scaffolds. In the second method, very small (about 10 nm to about 30 nm) and uniform size nanoparticles were pre-synthesized via a colloidal method and dispersed on a LSGM scaffold as a form of a solution.

In the first method (the “dispersion method”), a solution mixture was prepared by dissolving metal precursors (e.g., nitrate or citrate salts of the metal) of fixed concentration (20 mM) into various solvents (isopropyl alcohol, de-ionized water, and ethanol). A fixed volume (100 μL to 200 μL) of solution was then dropped and dispersed onto a LSGM scaffold, which naturally absorbed the precursors into the scaffold by capillary action. Following dispersion, the treated scaffold was subjected to a heat treatment process to remove organic substances at 500° C. for 30 minutes.

In the second method, platinum nanoparticles were synthesized by aqueous-based colloidal synthesis using cationic surface. The CₙTAB (where n=10, 12, 14, 16, or 18) was used as a cationic surfactant and platinum was provided as the K₂PtCl₄ precursor to form nanoparticle precursor (CₙTA)₂PtBr₄. NaBH₄ was added to the precursor and the mixture was incubated at 50° C. for 24 hours. Then, H₂ generated during the incubation process was vented for 20 minutes to produce platinum nanoparticles. By coulombic interactions between the charged surfactants and precursors, the size- and shape-tunable platinum nanoparticles were synthesized. Once synthesized, the particles were uniformly sprayed on the LSGM scaffold in the form of a mixed solution of water and the nanoparticles.

Transition metals such as silver, copper, cobalt, nickel, palladium, and platinum were tested. Platinum nanoparticles were made by colloidal synthesis, while nanoparticles of the other metals were made via the dispersion method described above. Morphology and dispersion of the metal nanoparticles were confirmed by analyzing the surface of the scaffold with various experimental controllable variables, including volume of the once-dropping solution, total number of drops, the temperature and time of the heat treatment, and the pretreatment of the scaffold surface. In particular, lower concentration and less volume of precursor solution forms smaller and well-dispersed nanoparticles. Moreover, temperature should be high enough to enable calcination, but low enough so as to not coarsen the nanoparticles.

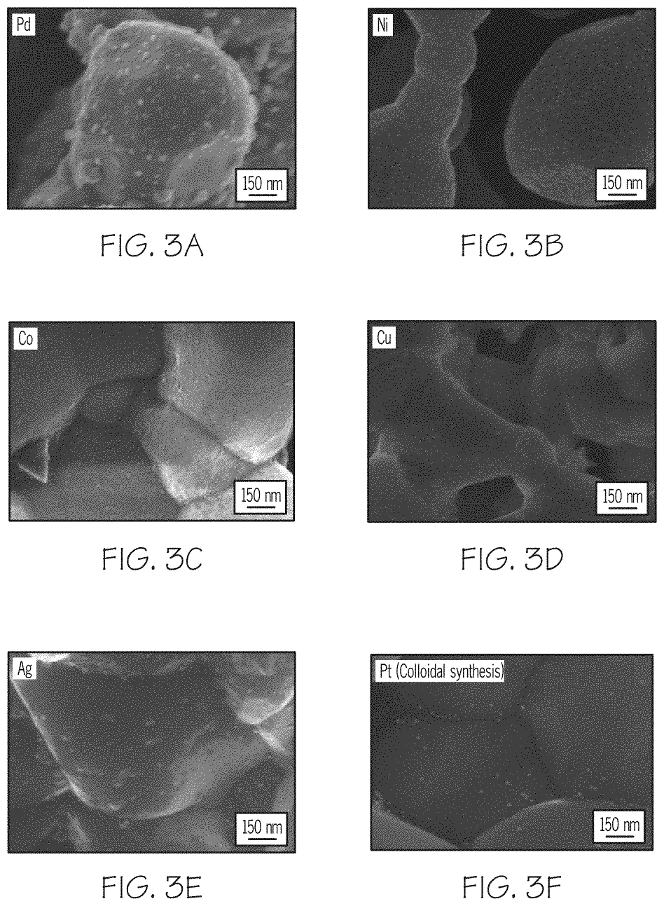

Although the final heat treatment conditions of each metal proceed differently depending on the melting point of the oxide form of each metal, the metals were synthesized under the same thermodynamic environment. Uniformly dispersed palladium (FIG. 3A), silver (FIG. 3E), and nickel (FIG. 3B) nanoparticles ranging in size from 20 nm to 30 nm were observed using SEM on the surface of the LSGM scaffold. In particular, as shown in FIG. 3B, a large number of nickel nanoparticles were synthesized very homogenously on the entire scaffold. However, copper (FIG. 3D) and cobalt (FIG. 3C) were observed in the form of metal layers or segregated particles coated with scaffolds rather than well-dispersed nanoparticles. In FIG. 3F, platinum nanoparticles that were even smaller than other cases were synthesized and dispersed by colloidal synthesis, although fewer nanoparticles were embedded. Accordingly, colloidal synthesis requires more steps to embed the same amount of catalysts embedded by infiltration method.

### Example 3

The distribution of nanoparticles was visually distinguished only when the amount of catalyst dispersed in the scaffold was changed, and the concentration and the amount of the initial solution determined empirically were suitable to achieve uniform dispersion of some metals. In particular, testing regarding changing the amount of dispersion was conducted for each of the metals, and nickel is used as a representative example herein.

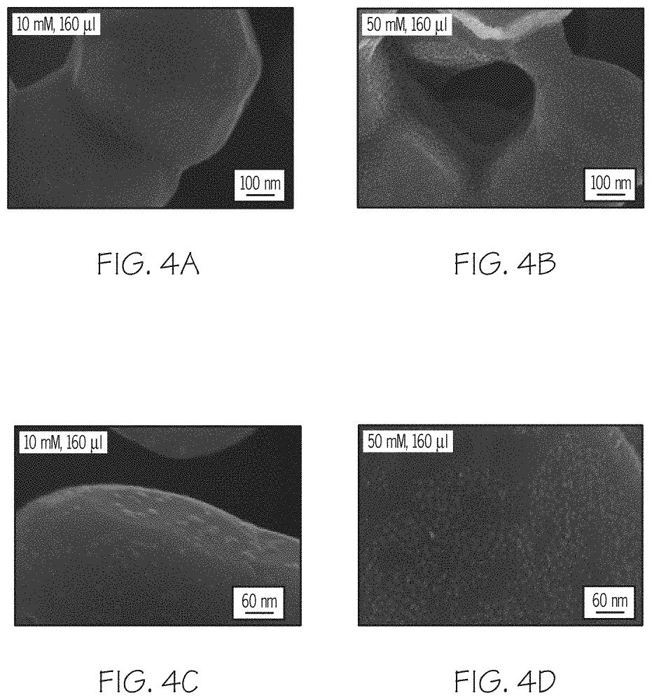

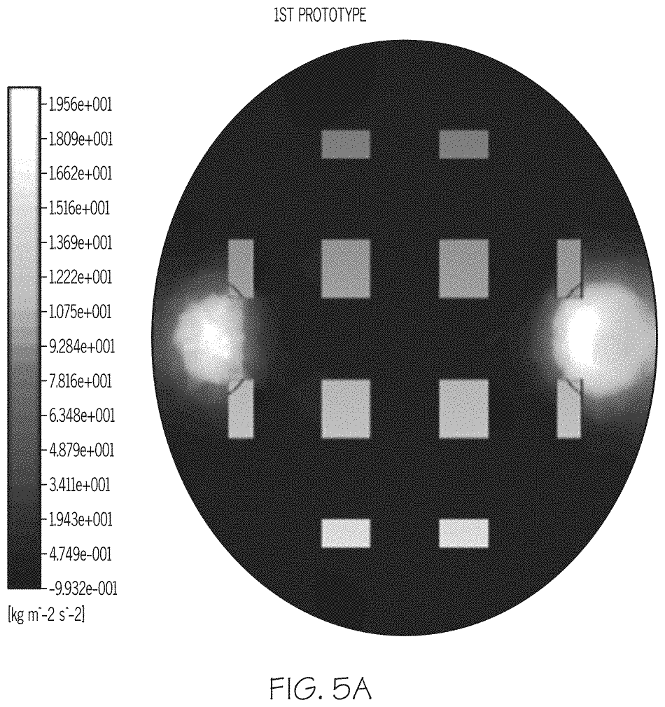

In this example, the concentration of the nickel solution was varied from 10 mM to 50 mM and used to infiltrate an LGSM scaffold. SEM images of the infiltrated scaffold at 10 mM and 50 mM are shown in FIGS. 4A-4D. In particular, FIGS. 4A and 4B are SEM images of Ni-infiltrated LGSM scaffold with 10 mM and 50 mM concentration solutions, respectively, while FIGS. 4C and 4D are the corresponding SEM images having a greater magnification. Notably, the amount of nuclei significantly increased with the amount of drop, and the size of each particle was larger in the sample treated with the solution of smaller concentration (10 mM; FIGS. 4A and 4C) as compared to the sample treated with the solution of a greater concentration (50 mM; FIGS. 4B and 4D).

### Example 4

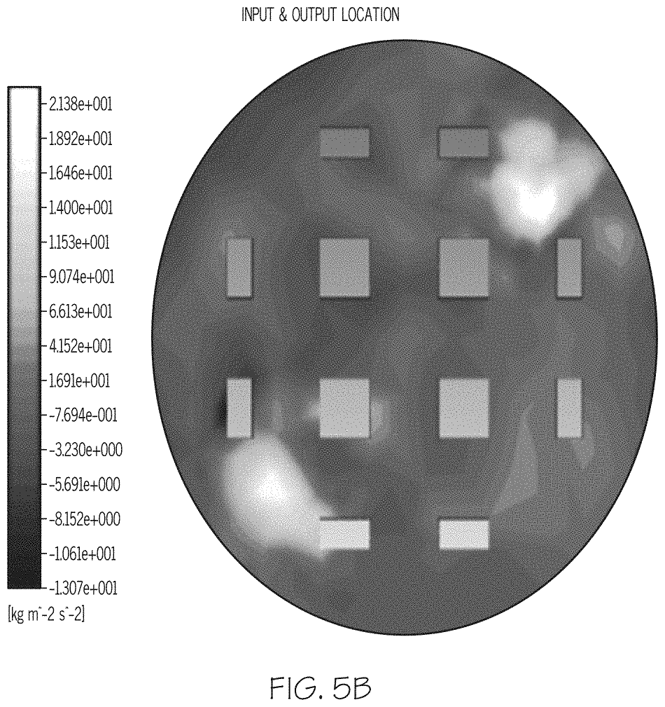

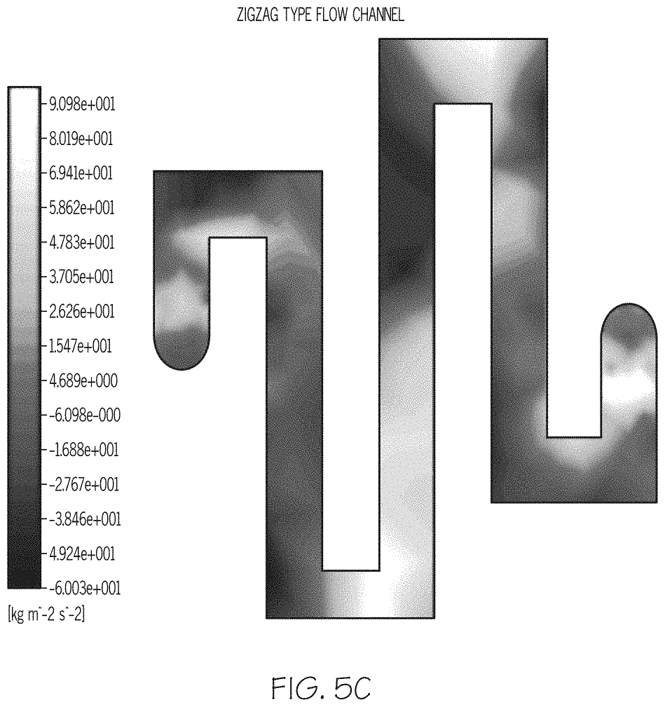

Studies were conducted to exclude morphologic effects of electrodes using channel flow design simulation of flow channels using ANSYS software. In particular, designs of flow channels were evaluated to identify a design with a high pressure gradient from one side of the electrode to the other, which is believed to drive the force of diffusion. The results of the simulations are shown in FIGS. 5A-5C. In the simulations, the design of the flow channel was changed to a zig-zag type design (FIG. 5C), which improved the rate of formation of ammonia of up to 5.21×10⁻¹⁰ mol/cm²*s.

The design of the flow channels shown in FIG. 5B was not tested experimentally. However, the zig-zag type design (FIG. 5C) showed better formation rates compared to the flow channel design shown in FIG. 5A for a pure nitrogen fed at a flow rate of 30 cm³/min. In particular, the simulation results show pressure gradient towards electrodes, which is the driving force of the gas flow. The zig-zag design of the flow channels in FIG. 5C shows high and large range of this value which indicates dynamic flow of the feed gas.

### Example 5

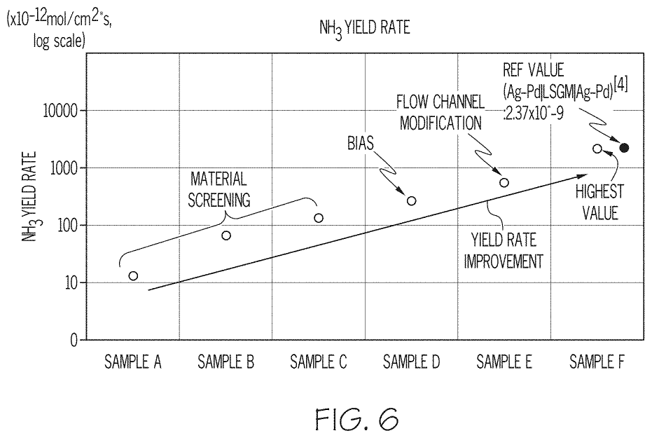

Asymmetric fuel cell configurations were also tested. In particular, the materials for each of the anode and cathode were varied. The NH₃ yield rate was measured for samples having a gold anode and gold cathode (Sample A), a platinum anode and a platinum cathode (Sample B), a silver anode and silver cathode (Samples C, D, and E), and a platinum anode and a silver-infiltrated LGSM cathode (Sample F), and the results are shown in FIG. 6. Samples A, B, and C used a voltage of 1.6 V while Samples D, E, and F used a voltage of 2 V. Sample E included the flow channel modification such that the flow channels were in the zig-zag configuration, while Samples A, B, C, D, and F used the flow channel configuration of FIG. 5A.

As shown in FIG. 6, the yield rate improved with the fuel cell modifications, and the formation rate of ammonia for the fuel cell including a platinum anode and a silver-infiltrated LGSM cathode (Sample F) was 2.03×10⁻⁹ mol/cm²*s, which is comparable to a reference value obtained using similar materials (Ag—Pd|LGSM|Ag—Pd; 2.37×10⁻⁹ mol/cm²*s).

### Example 6

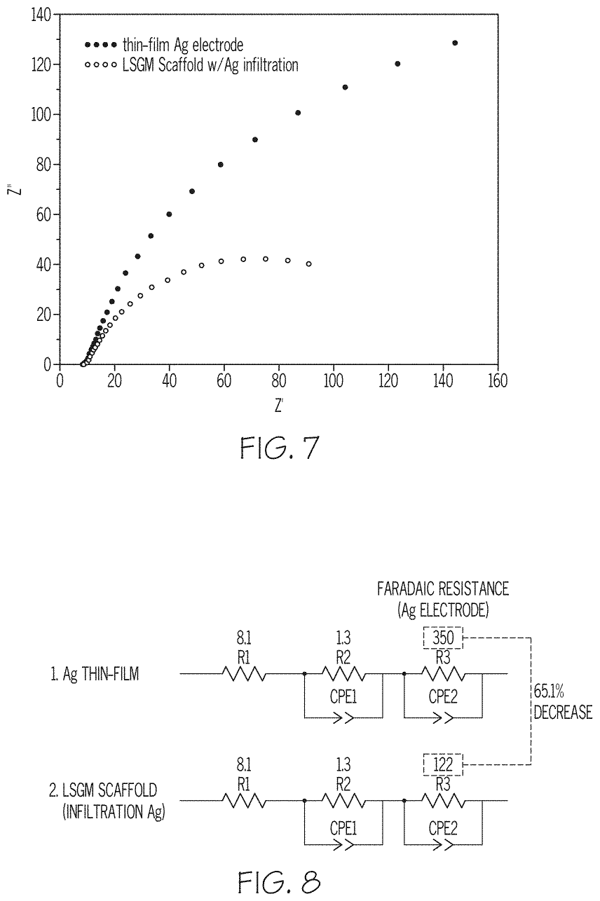

Electrochemical Impedance Spectroscopy (EIS) was performed using a simple thin-film silver electrode (Comparative) and a silver-infiltrated LSGM scaffold (Inventive). These prepared samples were then subjected to EIS. FIG. 7 provides the Nyquist plot of the real part of the impedance measurement (Z′) on the X-axis and the imaginary part of the impedance measurement (Z″) on the Y-axis. By adopting infiltrated electrodes, the electrochemical characteristics under conditions intended for ammonia synthesis are improved.

From a careful analysis of this data, which showed three semicircles, equivalent circuits were modeled, the results of which are shown in FIG. 8. The equivalent circuits include three resistors in series (R1, R2, and R3), with R2 and R3 each being parallel with a constant phase element (CPE1 and CPE2, respectively). R1 corresponds to the intercept of the Nyquist plot with the X-axis. R2 corresponds to a smaller semicircle adjacent the first. R3 corresponds to the remaining portion of the Nyquist plot.

As shown in FIG. 8, the Faradaic resistance decreases by 65.1% when using a silver-infiltrated LSGM electrode (122 Ohms), rather than a silver thin-film electrode (350 Ohms).

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

The singular forms “a”, “an” and “the” include plural referents, unless the context clearly dictates otherwise.

For the purposes of describing and defining the present disclosure it is noted that the term “about” is utilized in this disclosure to represent the inherent degree of uncertainty that may be attributed to any quantitative comparison, value, measurement, or other representation. The term “about” is also utilized in this disclosure to represent the degree by which a quantitative representation may vary from a stated reference without resulting in a change in the basic function of the subject matter at issue.

As used in this disclosure and in the appended claims, the words “comprise,” “has,” and “include” and all grammatical variations thereof are each intended to have an open, non-limiting meaning that does not exclude additional elements or steps.

Additionally, the term “consisting essentially of” is used in this disclosure to refer to quantitative values that do not materially affect the basic and novel characteristic(s) of the disclosure. For example, a chemical stream “consisting essentially” of a particular chemical constituent or group of chemical constituents should be understood to mean that the stream includes at least about 99.5% of a that particular chemical constituent or group of chemical constituents.

It should be understood that any two quantitative values assigned to a property may constitute a range of that property, and all combinations of ranges formed from all stated quantitative values of a given property are contemplated in this disclosure.

As used in this disclosure, terms such as “first” and “second” are arbitrarily assigned and are merely intended to differentiate between two or more instances or components. It is to be understood that the words “first” and “second” serve no other purpose and are not part of the name or description of the component, nor do they necessarily define a relative location, position, or order of the component. Furthermore, it is to be understood that the mere use of the term “first” and “second” does not require that there be any “third” component, although that possibility is contemplated under the scope of the present disclosure.

1. A solid oxide fuel cell comprising a cathode, an anode, and a solid oxide electrolyte
disposed between the anode and the cathode, wherein:
the solid oxide electrolyte comprises La_{0.8}Sr_{0.2}Ga_{0.83}Mg_{0.17}O_{2.815} (LSGM); and
the anode comprises a porous scaffold, the porous scaffold comprising LSGM and one or more metal nanoparticles disposed on the surface of the porous scaffold, wherein the metal nanoparticles are selected from the group consisting of platinum, nickel, gold, and combinations thereof.

2. The solid oxide fuel cell according to claim 1, wherein the cathode comprises a porous scaffold, the porous scaffold comprising LSGM and one or more metal nanoparticles disposed on the surface of the porous scaffold, wherein the metal nanoparticles are selected from the group consisting of platinum, nickel, gold and combinations thereof.

3. The solid oxide fuel cell according to claim 1, wherein the cathode comprises a porous scaffold, the porous scaffold comprising a solid oxide having metal-based catalysts disposed on one more surfaces of the porous scaffold.

4. The solid oxide fuel cell according to claim 1, wherein the cathode comprises La_{0.6}Sr_{0.4}Co_{0.2}Fe_{0.8}O₃ (LSCF) infiltrated with La₁₋ₓSrₓMnO₃ (LSM).

5. A method of producing ammonia in a fuel cell comprising:
ionizing hydrogen gas at an anode of the fuel cell by removing electrons to form hydrogen ions, the fuel cell comprising a cathode, the anode, and a proton-conducting electrolyte between the anode and the cathode, wherein:
the proton-conducting electrolyte comprises La_{0.8}Sr_{0.2}Ga_{0.83}Mg_{0.17}O_{2.815} (LSGM); and
the anode comprises a porous scaffold, the porous scaffold comprising LSGM and one or more metal nanoparticles disposed on the surface of the porous scaffold, wherein the metal nanoparticles are selected from the group consisting of platinum, nickel, gold, and combinations thereof;
passing the hydrogen ions through the proton-conducting electrolyte to the cathode;
passing the electrons from the anode to the cathode; and
passing nitrogen gas to the cathode, wherein the hydrogen ions and the nitrogen gas react to produce the ammonia.

6. The method according to claim 5, wherein the cathode comprises a porous scaffold, the porous scaffold comprising LSGM and one or more metal nanoparticles disposed on the surface of the porous scaffold, wherein the metal nanoparticles are selected from the group consisting of platinum, nickel, gold and combinations thereof.

7. The method according to claim 5, wherein the cathode comprises a porous scaffold, the porous scaffold comprising a solid oxide having metal based catalysts disposed on one or more surfaces of the porous scaffold.

8. The method according to claim 5, wherein the cathode comprises La_{0.6}Sr_{0.4}Co_{0.2}Fe_{0.8}O₃ (LSCF) infiltrated with La₁₋ₓSrₓMnO₃ (LSM).

9. The method according to claim 5, wherein passing the electrons from the anode to the cathode comprises passing the electrons from the anode to the cathode through an electronic circuit.
